(19) United States
(12) Patent Application Publication
(10) Pub. No.: US 2026/0131437 A1
(43) Pub. Date: May 14, 2026

(54) OPTICAL TOOL

(71) Applicant: Bruce Whitney, Tacoma, WA (US)

(72) Inventor: Bruce Whitney, Tacoma, WA (US)

(21) Appl. No.: 19/388,543

(22) Filed: Nov. 13, 2025

Related U.S. Application Data
(60) Provisional application No. 63/720,094, filed on Nov. 13, 2024.

(51) Int. Cl. B25B 27/14; G02C 13/00

(52) U.S. Cl. CPC B25B 27/14; G02C 13/001

(57) ABSTRACT

An optical tool may include a handle portion graspable by a user. An optical tool may include a cord-engaging portion extending from the handle portion, the cord-engaging portion comprising: a first elongated flattened portion, a second elongated flattened portion disposed at an oblique angle relative to the first elongated flattened portion; and bend joint defined between the first and second elongated flattened portions.

### CROSS-REFERENCE TO RELATED APPLICATION

This application claims the benefit of U.S. Provisional Application No. 63/720,094, filed Nov. 13, 2024, the entire contents of which are incorporated herein by reference.

### BRIEF SUMMARY

In some aspects, the techniques described herein relate to an optical tool, including: a handle portion graspable by a user; a cord-engaging portion extending from the handle portion, the cord-engaging portion including: a first elongated flattened portion; a second elongated flattened portion disposed at an oblique angle relative to the first elongated flattened portion; and bend joint defined between the first and second elongated flattened portions.

In some aspects, the techniques described herein relate to an optical tool, wherein the handle portion is integrally formed with the cord-engaging portion.

In some aspects, the techniques described herein relate to an optical tool, wherein the cord-engaging portion is secured within the handle portion.

In some aspects, the techniques described herein relate to an optical tool, wherein the second elongated flattened portion includes a distal tip with a tapered corner.

In some aspects, the techniques described herein relate to an optical tool, wherein the cross-sectional thickness of the first elongated flattened portion is greater than the cross-sectional thickness of the second elongated flattened portion.

In some aspects, the techniques described herein relate to an optical tool, wherein the cross-sectional thickness of the first elongated flattened portion decreases between the handle portion and the bend joint.

In some aspects, the techniques described herein relate to an optical tool, wherein the handle portion and the cord-engaging portion are integrally formed with polypropylene.

In some aspects, the techniques described herein relate to an optical tool, further including a plurality of web features extending between the handle portion and the first elongated flattened portion.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a first exemplary embodiment of an optical tool formed in accordance with the present disclosure.

FIG. 2 is top view of the optical tool of FIG. 1.

FIG. 3 is a cross-sectional view of the optical tool of FIG. 2, taken substantially across line 3-3.

FIG. 4 is a photo showing a first portion of a lens removal/installation for semi-rimless eyeglasses using an optical tool formed in accordance with the present disclosure.

FIG. 5 is a photo showing a second portion of a lens removal/installation for semi-rimless eyeglasses using an optical tool formed in accordance with the present disclosure.

FIG. 6 is a photo showing a third portion of a lens removal/installation for semi-rimless eyeglasses using an optical tool formed in accordance with the present disclosure.

FIG. 7 is an isometric view of a second exemplary embodiment of an optical tool formed in accordance with the present disclosure.

FIG. 8 is top view of the optical tool of FIG. 7.

FIG. 9 is a cross-sectional view of the optical tool of FIG. 8, taken substantially across line 9-9.

FIG. 10 is an isometric view of a third exemplary embodiment of an optical tool formed in accordance with the present disclosure.

FIG. 11 is a partial isometric view of the optical tool of FIG. 10.

FIG. 12 is top view of the optical tool of FIG. 10.

FIG. 13 is a cross-sectional view of the optical tool of FIG. 8, taken substantially across line 13-13.

### DETAILED DESCRIPTION

Glasses that have rims around the prescription lenses often become the focal point of a person's face. With rimless eyewear, the full facial features are exposed. Semi-rimmed glasses, also known as half-rim or half-rimless glasses, have a rim on part of the frames holding a lens, and on the other part a thin wire (e.g., a nylon cord) secures the lens in place. The rim on a half-rimless frame is most commonly on the top of the lens, although occasionally it is located on the bottom of the lens. This provides a certain “look” that is different from fully rimless eyewear. Semi-rimless glasses are also more sturdy than rimless styles, yet are also lightweight.

To install a lens within a half-rimless frame, a technician typically wraps a ribbon (e.g., wrapping or curling ribbon) around the wire and pulls the wire into place around a portion of the lens. More specifically, the lens may be placed against the rim portion of the frame, and with the ribbon wrapped around the wire, the ribbon is moved along the wire to secure it within a correspondingly-shaped and sized circumferential groove extending around the rimless portion of the lens. The wire is pulled by the ribbon until the wire is fully secured within the lens groove. The ribbon may then be slid toward a center of the lens and gently pulled out from between the lens and the wire.

To remove the lens, generally the opposite steps are taken. The ribbon may thread through a gap between the lens and the wire, typically where the frame changes from metal or plastic to the thin nylon cord. Once the ribbon is wrapped around the nylon wire, the ribbon is pulled from one side of the lens to the other, derailing the nylon cord on the lens and allowing it to be popped out.

Although a ribbon supports insertion of lenses into most nylon banded semi-rimless frames, a ribbon is ergonomically difficult to securely hold. Moreover, a ribbon can easily get lost or displaced. The present disclosure relates to an improved optical tool to better support installation and removal of lenses from semi-rimless glasses or the like.

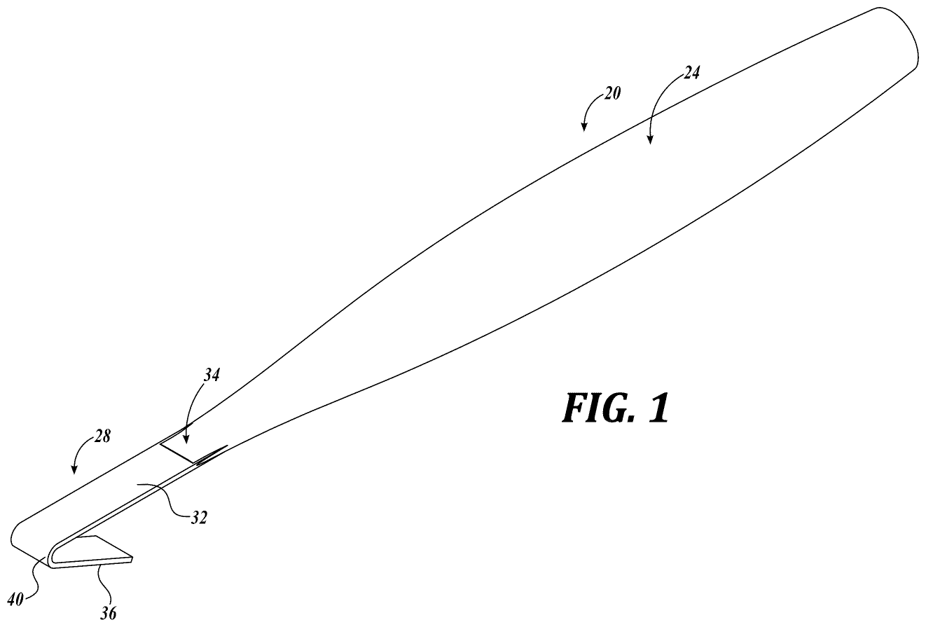

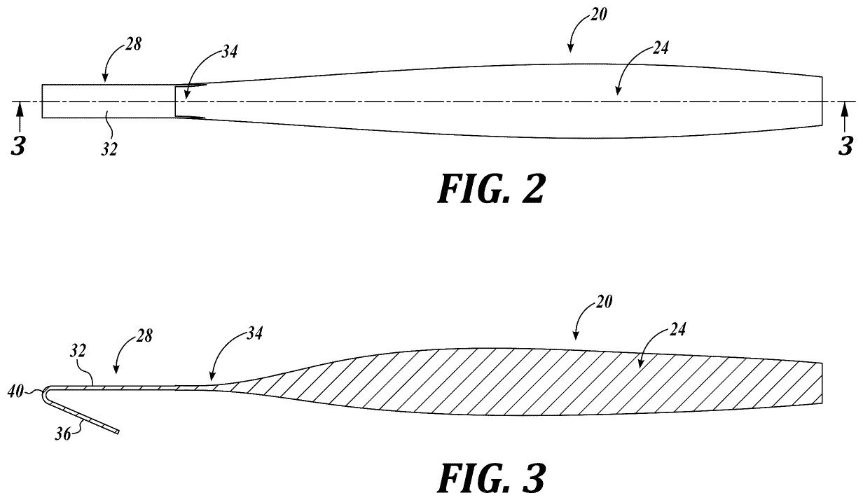

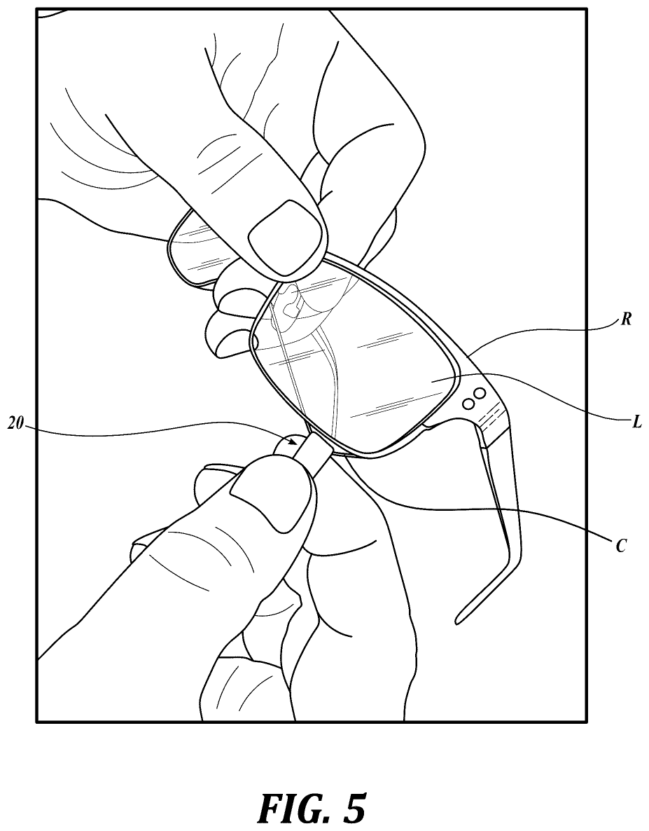

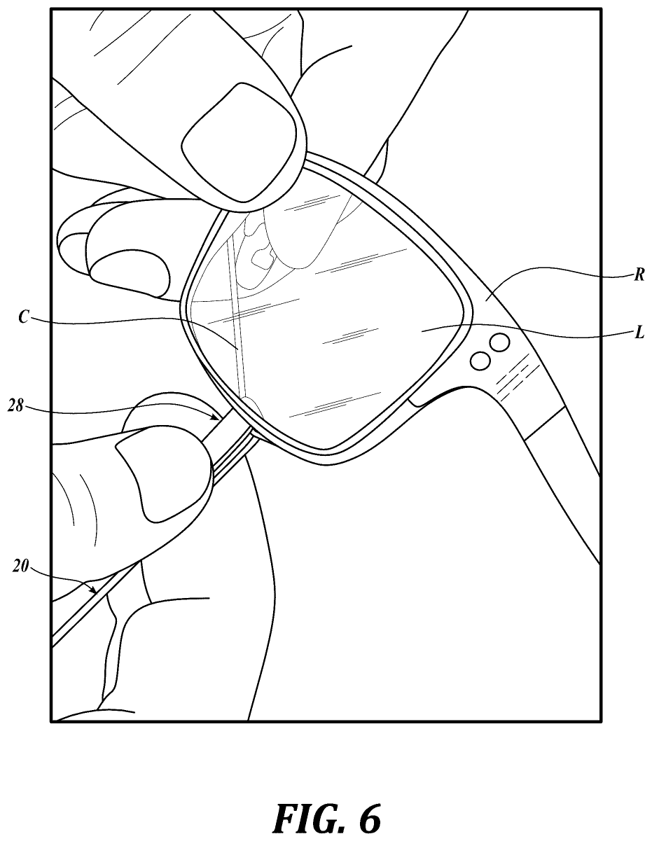

Referring to FIGS. 1-6, a first exemplary embodiment of an optical tool 20 formed in accordance with the present disclosure will now be described. The optical tool 20 generally includes a handle portion 24 graspable by a user and a cord-engaging portion 28 extending axially from the handle portion 24. The handle portion 24 is any suitable ergonomical shape that is graspable by a user for manipulation of the tool in installing/removing lenses. For instance, the handle portion 24 may be a generally elongated cylindrical shape that is generally tapered at its first and second opposing ends.

The first tapered end of the handle portion 24 may be a flattened tapered end that gradually transitions into a first elongated flattened portion 32 of the cord-engaging portion 28 at a transition junction 34. The first elongated flattened portion 32 of the cord-engaging portion 28 extends from a first tapered end of the handle portion 24 along generally the same longitudinal axis as the handle portion 24. The first elongated flattened portion 32 of the cord-engaging portion 28 extends a suitable length from the handle portion 24 to be suitably engageable with a nylon band of semi-rimless glasses without interference by the handle portion 24.

The first elongated flattened portion 32 of the cord-engaging portion 28 transitions into a second elongated flattened portion 36 of the cord-engaging portion 28, with a bend joint 40 defined therebetween. The bend joint 40 may position the second elongated flattened portion 36 at an oblique angle relative to the first elongated flattened portion 32 (and the longitudinal axis of the handle portion 24). For instance, the second elongated flattened portion may have an elongated axis that is at an angle of about 280-320 degrees (280-320°) from the elongated axis of the first elongated flattened portion 32.

The cord-engaging portion 28 may have a strength, rigidity, durability, flexibility, smoothness, etc., such that it is sufficiently durable to withstand a suitable amount of use, sufficiently flexible to.

The optical tool 20 may be formed from one or more materials, such as plastic (e.g., polypropylene). In some examples, the handle portion 24 and cord-engaging portion 28 of the optical tool 20 are integrally formed from one or more materials. For instance, the handle portion 24 and cord-engaging portion 28 may be integrally formed by injection molding (e.g., from polypropylene), 3D printing, etc.

The material of the optical tool 20 may be suitable for defining a sufficiently stiff cord-engaging portion 28, while at the same time at least somewhat deformable to at least somewhat follow a curvature of a lens. Further, the cord-engaging portion 28 may have a strength and rigidity such that it is sufficiently durable to withstand a suitable amount of use. Yet further, the cord-engaging portion 28 may have an exterior surface smoothness to sufficiently be inserted between and glide between a lens and a cord. In some examples, the cord-engaging portion 28 may be made from the same or similar material to package strapping tape. In some examples, the optical tool 20, including the cord-engaging portion 28 may be made from polypropylene.

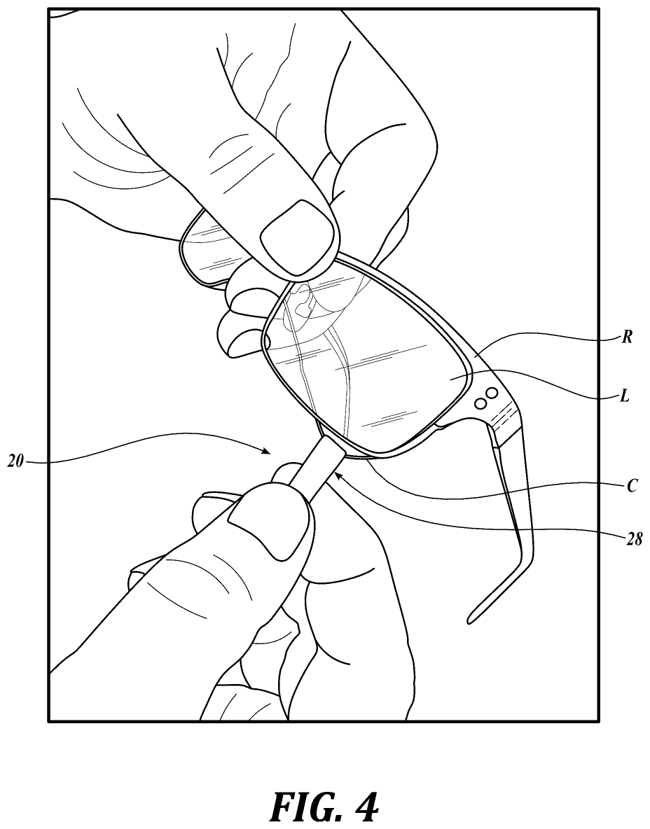

FIGS. 4-6 show the optical tool 20 in use for installing a lens L within a cord C that is attached to a rim R of semi-rimless glasses. The optical tool 20 is shown generally following a curvature of the lens L within a cord C that is attached to a rim R of semi-rimless glasses. The cord C is hooked by the cord-engaging portion 28, and with the cord C received generally within the interior crease of the bend joint 40, the cord-engaging portion 28 is pulled slowly across the edge of lens L. A user may grasp the cord-engaging portion 28, such as by pinching the first elongated flattened portion 32 and second elongated flattened portion 36 between his/her fingers, to secure the cord within the bend joint 40 of the cord-engaging portion 28 as it is moved across the lens. At the same time, the handle portion 24 may nest comfortably within the user's hand to facilitate ergonomic and secure grasp of the optical tool 20.

The bend joint 40 may be a sufficiently stiff joint formed by heat or other processing, and/or the bend joint 40 may instead be at least somewhat deformable. In any event, the bend joint 40 may sufficiently retain the second elongated flattened portion 36 in its position relative to the first elongated flattened portion 32 for engaging and securing a cord during lens installation/removal.

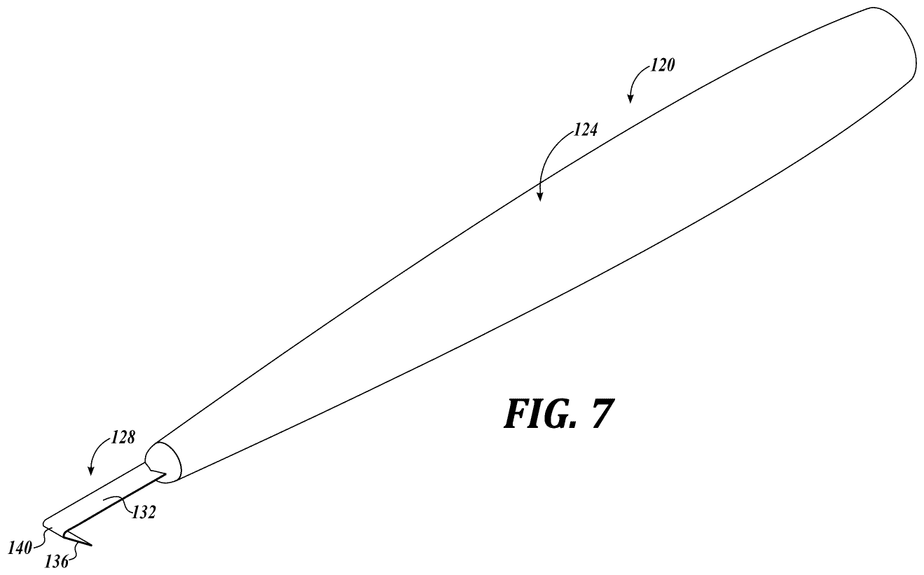

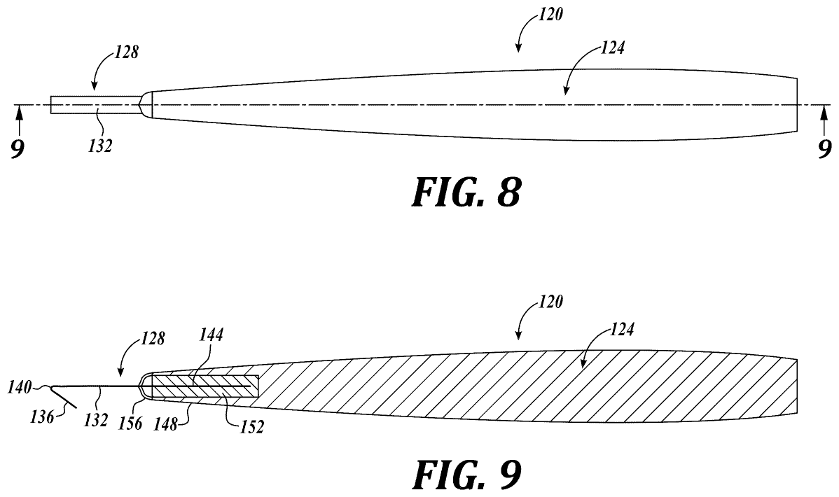

FIGS. 7-9 depict a second exemplary embodiment of an optical tool 120 formed in accordance with the present disclosure. The optical tool 120 is substantially similar to the optical tool 20 described above. In that regard, like part numbers are used to reference similar parts, except in the '100 series.

The optical tool 120 includes a handle portion 124 graspable by a user and a cord-engaging portion 128 extending axially from the handle portion 124. The handle portion 124 is any suitable ergonomical shape that is graspable by a user for manipulation of the tool in installing/removing lenses. For instance, the handle portion 124 may be a generally elongated cylindrical shape that is generally tapered at its first and second opposing ends.

The cord-engaging portion 128 similarly includes a first elongated flattened portion 132 that transitions into a second elongated flattened portion 136 with a bend joint 140 defined therebetween. The bend joint 140 may position the second elongated flattened portion 136 such that its elongated axis is about 280-320 degrees (280-320°) from the elongated axis of the first elongated flattened portion 132 (and the longitudinal axis of the handle portion 124).

The first tapered end of the handle portion 124 may include an axial cavity 148 configured to receive an extension portion 144 extending coaxially from the first elongated flattened portion 132. For instance, the extension portion 144 may be simply an extension of the material defining the first elongated flattened portion 132. A filler material 152 is disposed within the axial cavity 148 to secure the extension portion 144 within the axial cavity 148. For instance, the filler material 152 may be an epoxy resin or another sealant or curable material. An end cap 156 (such as with a slot to receive the first elongated flattened portion 132) may be secured to the first tapered end of the handle portion 124 to enclose the axial cavity 148.

The handle portion 124 and end cap 156 may be formed from any suitable material, such as plastic or metal. Moreover, the cord-engaging portion 128 may be any suitable material, such as plastic or metal.

Operation of the optical tool 120 may be substantially similar to that described above with respect to the optical tool 20.

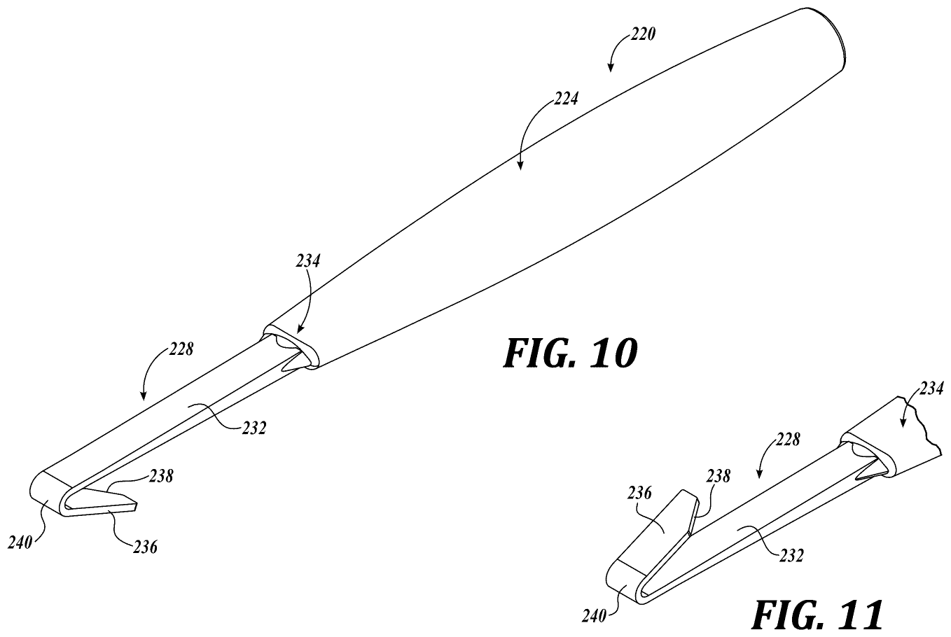

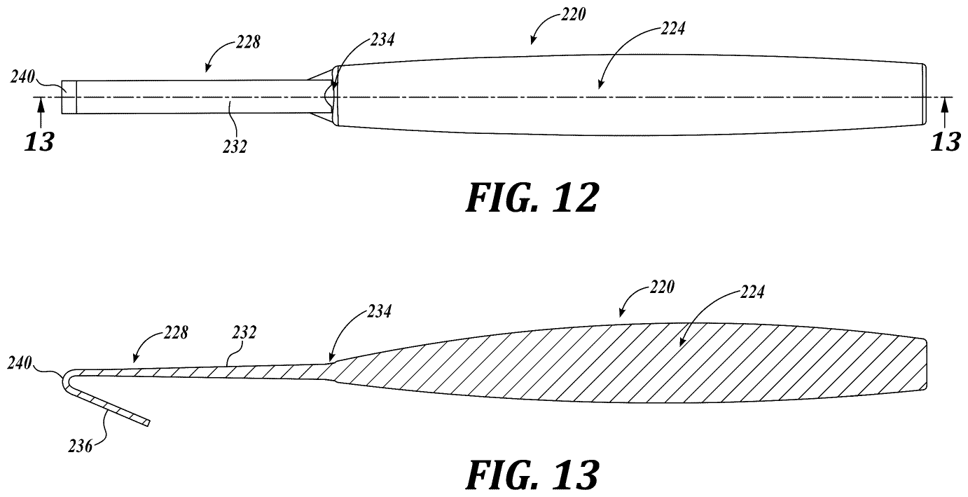

FIGS. 10-13 depict a third exemplary embodiment of an optical tool 220 formed in accordance with the present disclosure. The optical tool 220 is substantially similar to the optical tools 20 and 120 described above. In that regard, like part numbers are used to reference similar parts, except in the '200 series.

The optical tool 220 includes a handle portion 224 graspable by a user and a cord-engaging portion 228 extending axially from the handle portion 224. The handle portion 224 is any suitable ergonomical shape that is graspable by a user for manipulation of the tool in installing/removing lenses. For instance, the handle portion 224 may be a generally elongated cylindrical shape that is generally tapered at its first and second opposing ends.

The cord-engaging portion 228 similarly includes a first elongated flattened portion 232 that transitions into a second elongated flattened portion 236 with a bend joint 240 defined therebetween. The bend joint 240 may position the second elongated flattened portion 236 such that its elongated axis is about 280-320 degrees (280-320°) from the elongated axis of the first elongated flattened portion 232 (and the longitudinal axis of the handle portion 224).

The first tapered end of the handle portion 224 may be a flattened tapered end that gradually transitions into a first elongated flattened portion 232 of the cord-engaging portion 228 at a transition junction 234. The transition junction 234 may be configured for comfort in gripping with the fingers and/or hand of a user, it may be configured to define a suitably strong intersection of the handle portion 224 and the cord-engaging portion 228, and it may be configured to facilitate one-piece manufacturing of the optical tool 220, such as by injection molding.

In the depicted example, the handle portion 224 includes a curved proximal edge that intersects the outer surfaces of the cord-engaging portion 228. One or more structural support features may be defined between the curved proximal edge of the handle portion 224 and the outer surfaces of the cord-engaging portion 228. For instance, a web feature (not labeled) may extend between each of the four outer surfaces of the cord-engaging portion 228 (e.g., top, bottom, first side, and second side) and the curved proximal edge of the handle portion 224.

In addition to defining a suitably strong intersection of the handle portion 224 and the cord-engaging portion 228, the transition junction 234 shown in FIG. 10, or similar, can be formed by injection molding of a single piece optical tool 220. Further, the curved and/or ridged surfaces defined by the transition junction 234 can help support gripping/grasping of the optical tool 220 at the transition junction 234.

The first elongated flattened portion 232 of the cord-engaging portion 228 extends from a first tapered end of the handle portion 224 along generally the same longitudinal axis as the handle portion 224. The first elongated flattened portion 232 of the cord-engaging portion 228 extends a suitable length from the handle portion 224 to be suitably engageable with a nylon band, cord, etc., of semi-rimless glasses without interference by the handle portion 224.

The first elongated flattened portion 232 of the cord-engaging portion 228 transitions into a second elongated flattened portion 236 of the cord-engaging portion 228, with a bend joint 240 defined therebetween. The bend joint 240 may position the second elongated flattened portion 236 at an oblique angle relative to the first elongated flattened portion 232 (and the longitudinal axis of the handle portion 224). As noted above, the second elongated flattened portion 236 may have an elongated axis that is at an angle of about 280-320 degrees (280-320°) from the elongated axis of the first elongated flattened portion 232.

The cord-engaging portion 228 may be defined by a body having an overall flattened rectangular shape, with a width across the cord-engaging portion 228 substantially greater than a thickness or height of the body of the cord-engaging portion 228. The first elongated flattened portion 232 of the cord-engaging portion 228 may greater in cross-sectional thickness or height closer to the transition junction 234, and the first elongated flattened portion 232 may gradually decrease in cross-sectional thickness or height as the first elongated flattened portion 232 extends to the bend joint 240. An increased thickness or height near the transition junction 234 may enhance the structural integrity of the cord-engaging portion 228 and/or the transition junction 234. The change in thickness or height may also help facilitate removal of the optical tool 220 from an injection mold.

In some examples, the thickness or height of the cord-engaging portion 228 may be substantially the same along the bend joint 240 and the second elongated flattened portion 236, generally as shown. In some examples, the thickness or height of the cord-engaging portion 228 may continue to decrease as it extends along the bend joint 240 and the second elongated flattened portion 236 toward the distal tip. In any event, the cord-engaging portion 228 may be sufficiently thick to withstand the pulling forces against a cord when installing a lens, yet suitably thin to fit between a cord and lens and generally conform in shape to the cord/lens.

The second elongated flattened portion 236 may include a tapered corner portion 238 at its distal tip. The tapered corner portion 238 may help facilitate entry of the distal end of the second elongated flattened portion 236 between a cord and a lens. Of course, other features in addition to or instead of a tapered corner at the distal tip may instead be used to facilitate entry.

The optical tool 220 may be formed from one or more materials, such as plastic (e.g., polypropylene). In some examples, the handle portion 224 and cord-engaging portion 228 of the optical tool 220 are integrally formed from one or more materials. For instance, the handle portion 224 and cord-engaging portion 228 may be integrally formed by injection molding, 3D printing, etc.

The material of the optical tool 220 may be suitable for defining a sufficiently stiff cord-engaging portion 228, while at the same time at least somewhat deformable to at least somewhat follow a curvature of a lens. For instance, the optical tool 220 may be made from polypropylene.

Operation of the optical tool 220 may be substantially similar to that described above with respect to the optical tool 20.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Language such as “top”, “bottom”, “upper”, “lower”, “vertical”, “horizontal”, “lateral”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Likewise, the disclosure is not limited to various example embodiments given in this specification. Unless otherwise defined, technical and scientific terms used herein have the meaning as commonly understood by one of ordinary skill in the art to which this disclosure pertains. In the case of conflict, the present document, including definitions will control.

Note that titles or subtitles may be used in the examples for convenience of a reader, which in no way should limit the scope of the disclosure.

While illustrative embodiments have been illustrated and described, it will be appreciated that various changes can be made therein without departing from the spirit and scope of the invention.

1. An optical tool, comprising:
a handle portion graspable by a user;
a cord-engaging portion extending from the handle portion, the cord-engaging portion comprising:
a first elongated flattened portion;
a second elongated flattened portion disposed at an oblique angle relative to the first elongated flattened portion; and
bend joint defined between the first and second elongated flattened portions.

2. The optical tool of claim 1, wherein the handle portion is integrally formed with the cord-engaging portion.

3. The optical tool of claim 1, wherein the cord-engaging portion is secured within the handle portion.

4. The optical tool of claim 1, wherein the second elongated flattened portion includes a distal tip with a tapered corner.

5. The optical tool of claim 1, wherein the cross-sectional thickness of the first elongated flattened portion is greater than the cross-sectional thickness of the second elongated flattened portion.

6. The optical tool of claim 1, wherein the cross-sectional thickness of the first elongated flattened portion decreases between the handle portion and the bend joint.

7. The optical tool of claim 1, wherein the handle portion and the cord-engaging portion are integrally formed with polypropylene.

8. The optical tool of claim 1, further comprising a plurality of web features extending between the handle portion and the first elongated flattened portion.
